(19) United States
(12) Patent Application Publication
(10) Pub. No.: US 2026/0156184 A1
(43) Pub. Date: Jun. 4, 2026

(54) IN-VEHICLE ELECTRONIC SYSTEM AND DATA TRANSMISSION METHOD THEREOF BASED ON SOME/IP COMMUNICATION PROTOCOL

(71) Applicant: HON HAI PRECISION INDUSTRY CO., LTD., New Taipei City (TW)

(72) Inventors: Chih-Cheng LIU, New Taipei City (TW); Chih-Chieh SUN, New Taipei City (TW); Jun-Yu CHUANG, New Taipei City (TW)

(21) Appl. No.: 19/287,848

(22) Filed: Aug. 1, 2025

Related U.S. Application Data
(60) Provisional application No. 63/678,408, filed on Aug. 1, 2024.

(51) Int. Cl. H04L 67/12; H04L 47/24; H04L 47/6275

(52) U.S. Cl. CPC H04L 67/12; H04L 47/24; H04L 47/6275

(57) ABSTRACT

An in-vehicle electronic system and a data transmission method thereof based on the SOME/IP communication protocol are disclosed. The in-vehicle electronic system includes a first electronic control unit serving as a server configured to provide first and second services, and a second electronic control unit serving as a first client configured to request or subscribe to the services provided by the server. The first and second services each have a respective service priority. The first service has a higher service priority than the second service. In response to the first client simultaneously requesting the first and second services, or in response to the first client subscribing to both the first and second services and the events corresponding to the first and second services being triggered simultaneously, the server transmits data of the first and second services to the first client in order according to their service priorities.

### CROSS-REFERENCE TO RELATED APPLICATION

This application claims priority to U.S. Provisional Patent Application Ser. No. 63/678,408, filed Aug. 1, 2024, which is herein incorporated by reference in its entirety.

### BACKGROUND

### Technical Field

The present disclosure relates to an in-vehicle electronic system and a data transmission method thereof, and more particularly to an in-vehicle electronic system and a data transmission method thereof based on the SOME/IP communication protocol.

### Description of Related Art

With the increasing complexity of modern in-vehicle electronic systems, the demand for data exchange among electronic control units (ECUs) within a vehicle has significantly increased. In order to construct a highly modular and extensible in-vehicle system architecture, global automobile manufacturers and component suppliers have jointly established a standardized software platform referred to as Automotive Open System Architecture (AUTOSAR). This architecture facilitates the enhancement of development efficiency and system interoperability. Scalable service-Oriented MiddlewarE over IP (SOME/IP) is one of the core communication protocols supported by AUTOSAR and can be configured to implement Service-Oriented Communication (SoC). The SOME/IP protocol operates over an Internet Protocol (IP) network, supports point-to-point and broadcast/multicast transmission, and allows ECUs to exchange data through service publication and subscription. Each service may include one or more methods and events, thereby flexibly fulfilling the data transmission requirements of different automotive applications.

AUTOSAR also promotes a design mechanism called “Signal to Service” (S2S), which encapsulates data originally transmitted as signals in a Controller Area Network (CAN) or Local Interconnect Network (LIN) into services defined by SOME/IP, enabling such signals to be transmitted as services in an Ethernet environment. This transformation improves the flexibility of data flow and the maintainability of the system. For example, a vehicle speed signal originally transmitted via CAN may be converted into a SOME/IP event. The event is provided by the sensor ECU serving as a server and subscribed to and received by Advanced Driver Assistance Systems (ADAS) or an In-Vehicle Infotainment System (IVI) serving as clients. This mechanism not only simplifies the integration between heterogeneous networks but also contributes to realizing the flexibility and reusability required by a Software-Defined Vehicle (SDV).

However, in existing in-vehicle electronic systems, the S2S mechanism of SOME/IP still lacks a clear mechanism for controlling transmission order. When multiple clients subscribe to different event-based services provided by the same server and these events are triggered simultaneously, the server must send responses to all subscribed clients. During this process, issues such as inconsistent data transmission order or transmission delays may occur, thereby affecting the stability and real-time performance of the system. Moreover, different types of applications impose different requirements on the immediacy of service responses. For instance, entertainment applications can tolerate a certain level of delay, whereas safety-related applications require real-time processing. In the absence of a priority mechanism, if the server processes a request from an entertainment client before that of a safety-critical client, the response to safety-related data may be delayed, which could pose a risk to driving safety. Therefore, determining how to adjust the response order according to the importance of the service or application is a critical issue for improving the performance and reliability of SOME/IP applications.

### SUMMARY

In order to solve the aforementioned problem, one aspect of the present disclosure provides an in-vehicle electronic system based on the SOME/IP communication protocol which includes a first electronic control unit and a second electronic control unit. The first electronic control unit serves as a server configured to provide a first service and a second service. The first service and the second service each have a service priority, and the service priority of the first service is higher than the service priority of the second service. The second electronic control unit serves as a first client configured to request or subscribe to services provided by the server. In response to the first client simultaneously requesting the first service and the second service, or in response to the first client subscribing to the first service and the second service and events corresponding to the first service and the second service being triggered simultaneously, the server is configured to transmit data of the first service and data of the second service to the first client in sequence based on the service priorities.

In some embodiments of the present disclosure, the in-vehicle electronic system further includes a third electronic control unit serving as a second client. Each of the first client and the second client subscribes to the first service and has a first subscription priority corresponding to the first service. In response to the event corresponding to the first service being triggered, the server is configured to sequentially transmit the data of the first service to the first client and the second client according to the first subscription priorities, wherein the first subscription priority of the first client is higher than the first subscription priority of the second client.

In some embodiments of the present disclosure, each of the first client and the second client further subscribes to the second service and has a second subscription priority corresponding to the second service. In response to the events corresponding to the first service and the second service being triggered simultaneously, the server is configured to transmit the data of the first service to the first client and the second client first, based on the service priorities, and then to transmit the data of the second service to the first client and the second client.

In some embodiments of the present disclosure, the server is further configured to sequentially transmit the data of the first service to the first client and the second client based on the first subscription priorities, and to sequentially transmit the data of the second service to the first client and the second client based on the second subscription priorities, wherein the second subscription priority of the first client is higher than the second subscription priority of the second client.

In some embodiments of the present disclosure, in response to the first client and the second client subscribing to the first service, each of the first client and the second client presets the respective first subscription priority to be provided to the server. The server is configured to determine whether to reject the subscriptions of the first client and the second client to the first service based on the first subscription priorities provided by the first client and the second client.

In some embodiments of the present disclosure, in response to the first subscription priority provided by the first client exceeding a preset range or having an incorrect format, the server rejects the subscription of the first client to the first service, and transmits an error notification to the first client to notify the first client to reset the first subscription priority.

In some embodiments of the present disclosure, in response to the first subscription priority provided by the second client being higher than the first subscription priority provided by the first client, the server rejects the subscription of the second client to the first service, and transmits an error notification to the second client to notify the second client to reset the first subscription priority.

In some embodiments of the present disclosure, in response to the first client and the second client subscribing to the first service, each of the first client and the second client sets the first subscription priority in the first 8 bits of the Reserved field in a header of their respective SOME/IP messages during the service discovery phase of SOME/IP.

In some embodiments of the present disclosure, the in-vehicle electronic system employs an AUTOSAR architecture, and the service priorities of the first service and the second service are predefined in an ARXML file of the AUTOSAR architecture.

In some embodiments of the present disclosure, the ARXML file of the AUTOSAR architecture further defines latencies and bandwidths of the first service and the second service.

Another aspect of the present disclosure provides a data transmission method based on the SOME/IP communication protocol, which is suitable for an in-vehicle electronic system including a first electronic control unit and a second electronic control unit. The first electronic control unit serves as a server configured to provide a first service and a second service. The second electronic control unit serves as a first client to request or subscribe to services provided by the server. The data transmission method includes the following steps: predefining respective service priorities for the first service and the second service, wherein the service priority of the first service is higher than the service priority of the second service; in response to the first client simultaneously requesting the first service and the second service, or in response to the first client subscribing to the first service and the second service and events corresponding to the first service and the second service being triggered simultaneously, comparing the service priorities of the first service and the second service by the server; first transmitting data of the first service to the first client by the server based on a comparison result of the service priorities; transmitting data of the second service to the first client by the server after transmitting the data of the first service to the first client.

In some embodiments of the present disclosure, the in-vehicle electronic system further includes a third electronic control unit serving as a second client. The data transmission method includes the following steps: subscribing to the first service by the first client and the second client; setting a respective first subscription priority corresponding to the first service for each of the first client and the second client, wherein the first subscription priority of the first client is higher than the first subscription priority of the second client; in response to the event corresponding to the first service being triggered, comparing the first subscription priorities of the first client and the second client by the server; transmitting the data of the first service to the first client by the server based on a comparison result of the first subscription priorities; transmitting the data of the first service to the second client by the server after transmitting the data of the first service to the first client.

In some embodiments of the present disclosure, the data transmission method further includes the following steps: subscribing to the second service by the first client and the second client; setting a respective second subscription priority corresponding to the second service for each of the first client and the second client, wherein the second subscription priority of the first client is higher than the second subscription priority of the second client; in response to the events corresponding to the first service and the second service being simultaneously triggered, comparing the service priorities of the first service and the second service by the server; transmitting the data of the first service to the first client and the second client by the server based on the comparison result of the service priorities; transmitting the data of the second service to the first client and the second client by the server after transmitting the data of the first service to the first client and the second client.

In some embodiments of the present disclosure, the step of transmitting the data of the first service to the first client and the second client by the server based on the comparison result of the service priorities includes the following steps: comparing the first subscription priorities of the first client and the second client by the server; transmitting the data of the first service to the first client by the server based on the comparison result of the first subscription priorities; transmitting the data of the first service to the second client by the server after transmitting the data of the first service to the first client.

In some embodiments of the present disclosure, the step of transmitting the data of the second service to the first client and the second client includes the following steps: comparing the second subscription priorities of the first client and the second client by the server; transmitting the data of the second service to the first client by the server based on a comparison result of the second subscription priorities; transmitting the data of the second service to the second client by the server after transmitting the data of the second service to the first client.

In some embodiments of the present disclosure, the step of setting the respective first subscription priority corresponding to the first service for each of the first client and the second client includes the following steps: presetting the respective first subscription priority by each of the first client and the second client; providing the first subscription priorities set by the first client and the second client to the server; determining whether to reject the subscriptions of the first client and the second client to the first service by the server based on the first subscription priorities provided by the first client and the second client.

In some embodiments of the present disclosure, the step of setting the respective first subscription priority further includes the following step: in response to the first subscription priority provided by the first client exceeding a preset range or having an incorrect format, rejecting the subscription of the first client to the first service by the server and transmitting an error notification to the first client to notify the first client to reset the first subscription priority.

In some embodiments of the present disclosure, the step of setting the respective first subscription priority further includes the following step: in response to the first subscription priority provided by the second client being higher than the first subscription priority provided by the first client, rejecting the subscription of the second client to the first service by the server and transmitting an error notification to the second client to notify the second client to reset the first subscription priority.

In some embodiments of the present disclosure, the step of presetting the respective first subscription priority by each of the first client and the second client includes the following step: setting the respective first subscription priority in the first 8 bits of the Reserved field in the header of their respective SOME/IP messages during the service discovery phase of SOME/IP by the first client and the second client.

In some embodiments of the present disclosure, the in-vehicle electronic system employs an AUTOSAR architecture, and the step of predefining the respective service priorities for the first service and the second service includes the following step: predefining the respective service priorities of the first service and the second service in an ARXML file of the AUTOSAR architecture.

In summary, according to the in-vehicle electronic system and the data transmission method provided in the present disclosure, the immediacy of data transmission can be ensured. First, by assigning priorities to all services provided by the server, safety-related critical data can be transmitted preferentially. Second, by assigning priorities to all contending clients, safety-related critical data can be preferentially transmitted to the electronic control units associated with functional domains for safe driving, thereby ensuring the immediacy of critical data and reducing driving risks.

### BRIEF DESCRIPTION OF THE DRAWINGS

The embodiments of the present disclosure may be understood from the following detailed description taken in conjunction with the accompanying drawings. It should be noted that the various features are not necessarily drawn to scale as practiced in the industry. In fact, for purposes of clarity of discussion, the dimensions of various features may be arbitrarily enlarged or reduced.

FIG. 1 is a schematic diagram of an in-vehicle electronic system based on the SOME/IP communication protocol according to an embodiment of the present disclosure.

FIG. 2 is a flowchart of a data transmission method based on the SOME/IP communication protocol according to an embodiment of the present disclosure.

FIG. 3 is a flowchart of a data transmission method based on the SOME/IP communication protocol according to another embodiment of the present disclosure.

FIG. 4 is a flowchart illustrating a step of the data transmission method of FIG. 3.

FIG. 5 is a flowchart of a data transmission method based on the SOME/IP communication protocol according to another embodiment of the present disclosure.

### DETAILED DESCRIPTION

The present disclosure is described in detail through the following embodiments. It should be noted that the description of the embodiments of the present disclosure provided herein is merely for illustrative purposes, and is not intended to disclose all possible embodiments exhaustively, nor to limit the specific embodiments of the present disclosure. In addition, identical reference numerals used in the drawings and the specification, as far as possible, denote identical or similar elements.

It should be understood that, although terms such as “first” and “second” may be used herein to describe various features, such terms should not limit such features. These terms are merely used to distinguish one feature from another.

The terminology used herein is intended solely for describing particular embodiments, and is not intended to limit the scope of the claimed invention. Unless otherwise specified, the singular forms of “a” or “the” as used herein may also include the plural forms.

In the following description and claims, the term “coupled” and its derivatives may be used. In certain embodiments, “coupled” may refer to two or more components being in direct physical or electrical contact with each other, or not being in direct contact with each other. “Coupled” may also refer to two or more components cooperating or interacting with each other.

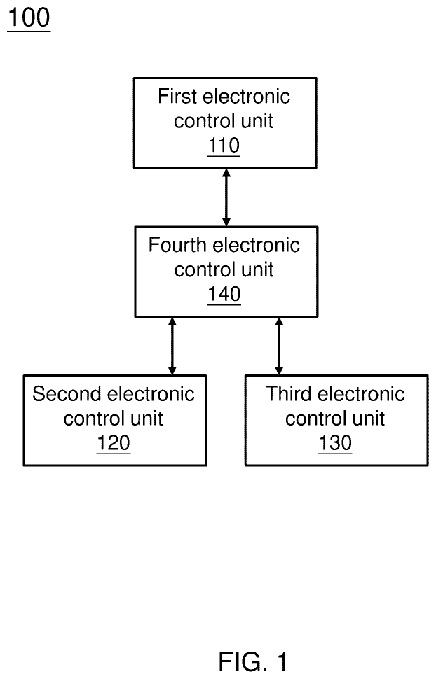

Reference is made to FIG. 1. FIG. 1 is a schematic diagram of an in-vehicle electronic system based on the SOME/IP communication protocol according to an embodiment of the present disclosure. The in-vehicle electronic system 100 may include a first electronic control unit (ECU) 110, a second electronic control unit 120, and a third electronic control unit 130. The first electronic control unit 110, the second electronic control unit 120, and the third electronic control unit 130 are electrically connected to each other and can transmit signals or data via wired or wireless means. In the present embodiment, the first electronic control unit 110 may serve as a server for providing multiple services. These services may include event-based services or request-based services. The second electronic control unit 120 and the third electronic control unit 130 may serve as clients for requesting or subscribing to at least one service from the server.

For example, the first electronic control unit 110 may be a Cross-Domain Control Unit (XCU). The XCU is a high-performance control unit in a centralized in-vehicle control architecture, and is configured to integrate and coordinate the logic and data flows among different functional domains. The XCU can perform cross-domain coordinated control as well as data convergence and processing. For instance, the XCU may integrate control logic and data exchange of different functional domains such as ADAS, IVI, body control, battery management, and powertrain systems. Additionally, the XCU can centrally process data from various sensors, ECUs, and CAN/LIN buses to perform logical operations, data fusion, and strategy decision-making.

The second electronic control unit 120 may be an Autonomous Driving Control Unit (ADCU), which is configured for autonomous driving sensor data fusion, behavior decision-making, path planning, etc. The third electronic control unit 130 may be an In-Vehicle Infotainment (IVI) system, which is configured for multimedia playback, navigation, voice control, display screen management, networked applications, direct user interaction, etc.

In one embodiment, the in-vehicle electronic system 100 may further include a fourth electronic control unit 140. The fourth electronic control unit 140 may be, for example, a gateway, which is configured for data conversion between different interfaces (e.g., between CAN and Ethernet or between LIN and CAN) and protocol conversion (e.g., Signal-to-Service (S2S)). Thus, communication among the first electronic control unit 110, the second electronic control unit 120, and the third electronic control unit 130 may be carried out via the fourth electronic control unit 140. In another embodiment, the gateway may be directly integrated into one of the electronic control units, such as the XCU. Thus, for example, the first electronic control unit 110 functioning as the XCU may communicate directly with the second electronic control unit 120 and the third electronic control unit 130 via a built-in gateway module.

Although FIG. 1 illustrates only one server and two clients, this is solely for the purpose of facilitating the explanation of the data transmission process described below. It will be appreciated by those skilled in the art that the in-vehicle electronic system 100 may include multiple different electronic control units serving as different servers for providing various services that three or more clients may request and/or subscribe to.

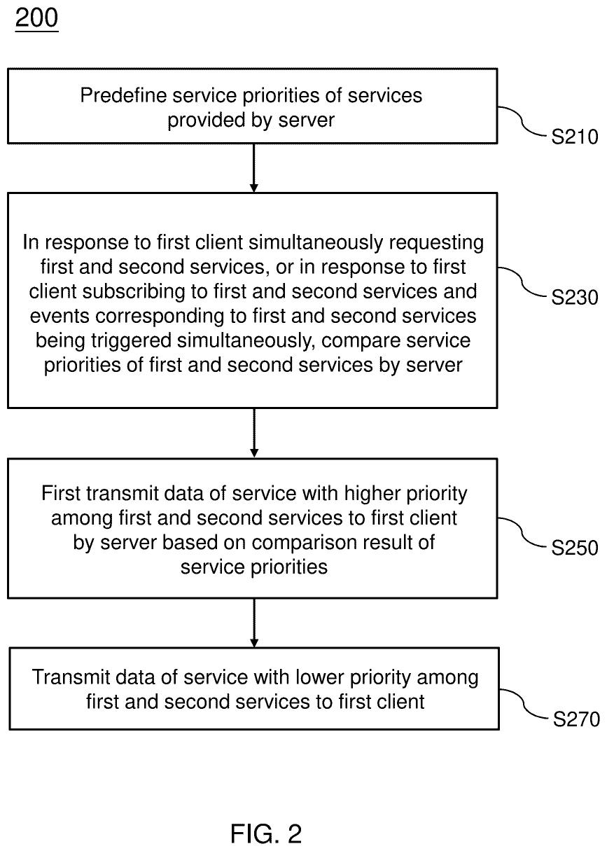

References are made to FIG. 1 and FIG. 2. FIG. 2 is a flowchart of a data transmission method 200 based on the SOME/IP communication protocol according to an embodiment of the present disclosure. The data transmission method 200 is applicable to the in-vehicle electronic system 100 shown in FIG. 1. First, in step S210, the service priorities of the services provided by the server are predefined. In one embodiment, the first electronic control unit 110 (e.g., XCU) serving as the server may provide at least a first service (e.g., radar service) and a second service (e.g., audio-visual service). Each of these services has its own service priority predefined by the user/manufacturer. This enables determining which service to respond to first when an event corresponding to the service is triggered or a request for the service is issued, based on the service priority.

In one embodiment, since the in-vehicle electronic system 100 employs the AUTOSAR architecture, the service priorities for all services provided by the server can be predefined in the ARXML files of the AUTOSAR architecture. ARXML, which stands for AUTOSAR XML File, is an XML-formatted description file defined by AUTOSAR. ARXML is used to describe the structure and configuration of various components within the in-vehicle software system. It also defines parameters for various services, such as service name (ID), signal services, transmission parameters, data types, etc. Reference is made to Table 1. Table 1 is an example of the ARXML file provided in this disclosure. In the present embodiment, the service priority may comprise 8 bits, meaning the service priority range spans from 0 to 255, where a smaller number indicates a higher service priority. However, this disclosure is not limited to this configuration. In other words, the service priority range may be broader, and larger numbers may also be defined as having higher service priority.

TABLE 1

| | | | | Band- |
|---|---|---|---|---|
| | | Prior- | Latency | width |
| Service Name | Signal Service | ity | (ms) | (Mbps) |
| ADAS | ADAS Status | 10 | 5 | 20 |
| Acceleration | Longitudinal Acceleration | 1 | 5 | 1 |
| Angular Velocity | Lateral Acceleration | 1 | 5 | 1 |
| Body | Vehicle Body Status | 50 | 20 | 5 |
| Cabin | Cabin Status | 100 | 50 | 5 |
| Chassis | Chassis Status | 30 | 10 | 10 |
| Connectivity | Network Connection Status | 40 | 10 | 1 |
| Current Location | GPS Location | 200 | 100 | 1 |
| Driver | Driver Status | 100 | 50 | 2 |
| Exterior | Exterior Light Status | 90 | 100 | 2 |
| OBD | Diagnostics | 70 | 50 | 5 |
| Powertrain | Powertrain Status | 20 | 5 | 10 |
| Service | Remote Diagnostics | 210 | 50 | 10 |
| Trailer | Trailer Status | 100 | 50 | 1 |
| Version | Version Information | 255 | 50 | 1 |

As shown in Table 1, in one embodiment, the ARXML file further defines the latency and bandwidth for each service. These parameters enhance the scalability of the data transmission method disclosed herein, for example, enabling integration with features such as Time-Sensitive Networking (TSN) or Quality of Service (QoS).

Reference is made to FIG. 2. In step S230, in response to the first client simultaneously requesting the first service and the second service, or in response to the first client subscribing to both the first service and the second service and events corresponding to both services being triggered simultaneously, the server compares the service priorities of the first service and the second service. Then, in step S250, based on the comparison result of the service priorities, the server transmits data for the service with the higher priority among the first service and the second service to the first client first. Subsequently, in step S270, after transmitting the data of the service with higher priority among the first service and the second service to the first client, the data of the service with lower priority among the first service and the second service is transmitted to the first client.

Specifically, based on the aforementioned example, assume that the second electronic control unit 120 (e.g., ADCU) serving as the first client subscribes to the first service (e.g., radar service) and the second service (e.g., audio-visual service) provided by the first electronic control unit 110 (e.g., XCU) serving as the server. When events corresponding to these two services are triggered simultaneously, the server compares the service priorities of the first service and the second service. In this example, the service priority of the radar service is predefined as higher than that of the audio-visual service. That is, in the ARXML file, the numerical value for the radar service's priority is smaller than that for the audio-visual service. Consequently, based on this priority comparison, the server transmits data for the radar service, which has the higher priority, to the client first. Subsequently, data for the audio-visual service with the lower priority is transmitted to the same client. This approach enables the XCU to avoid simultaneously transmitting both radar and audio-visual service data to the ADCU, thereby reducing the risk of data loss or miscommunication that could compromise the stability and real-time performance of the in-vehicle electronic system 100.

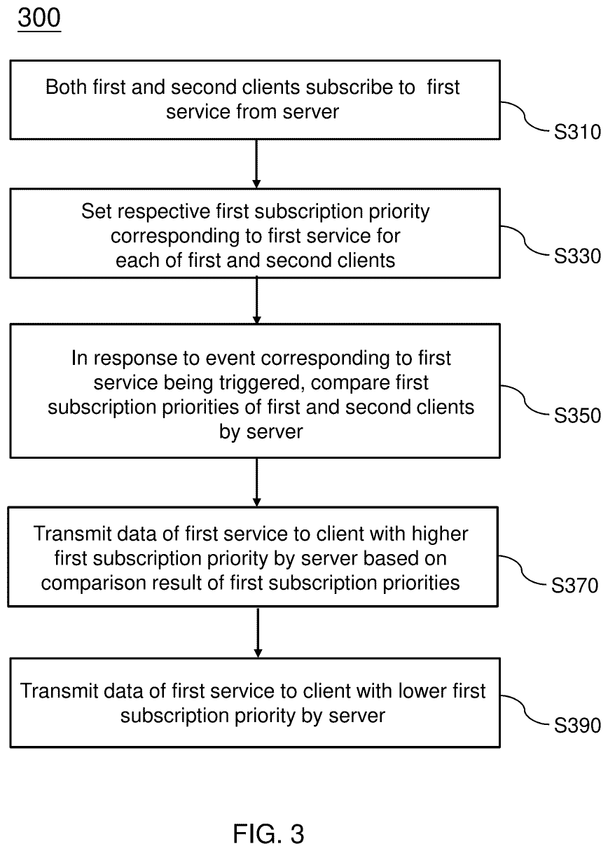

References are made to FIG. 1 and FIG. 3. FIG. 3 is a flowchart of a data transmission method 300 based on the SOME/IP communication protocol according to another embodiment of the present disclosure. First, in step S310, both the first client and the second client subscribe to the first service from the server. Specifically, based on the aforementioned example, assume that the second electronic control unit 120 (e.g., ADCU) serving as the first client and the third electronic control unit 130 (e.g., IVI) serving as the second client both subscribe to the first service (e.g., radar service) from the first electronic control unit 110 (e.g., XCU) serving as the server.

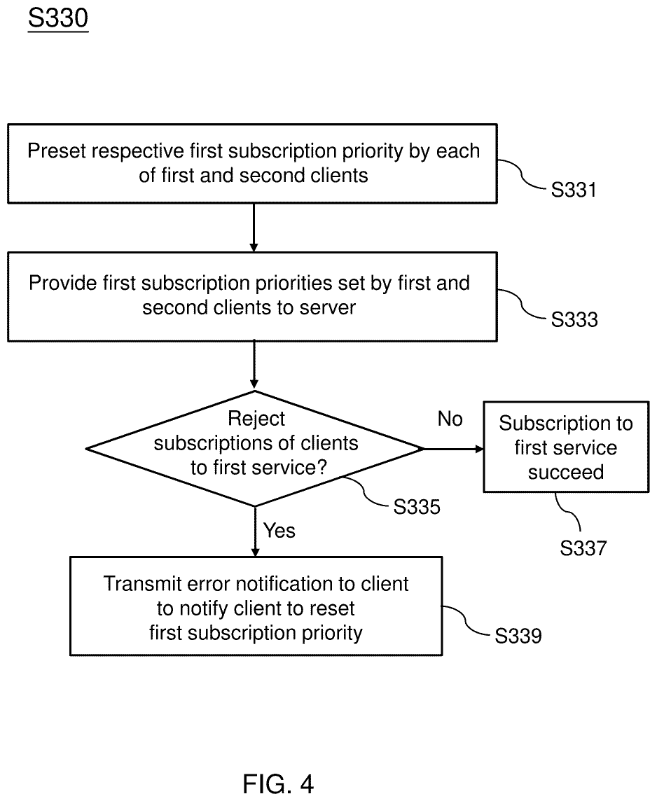

Next, in step S330, the first client and second client each set their respective first subscription priority for the first service. Specifically, reference is made to FIG. 4. FIG. 4 is a flowchart illustrating step S330 based on the data transmission method 300 of FIG. 3. First, in step S331, the first client and second client each preset their respective first subscription priority. Specifically, SOME/IP provides a Service Discovery (SD) module, which is used for service registration and search during the initialization phase, thereby enabling clients to dynamically connect to target services. In the present embodiment, the data transmission method utilizes the message format of SOME/IP, allowing a client to insert the value of the first subscription priority value into the first 8 bits of the “Reserved” field (which has a 24-bit space) in the SOME/IP header (i.e., the first subscription priority ranges from 0 to 255). The smaller the value of the first subscription priority, the higher the priority it represents. However, the present disclosure is not limited thereto. In other words, the range of the subscription priority may be larger, and a higher numerical value may also be defined as a higher subscription priority.

Next, in step S333, the first client and second client provide their set first subscription priority to the server. Then, in step S335, the server determines whether to reject the first client and second client's subscription to the first service based on the first subscription priority provided by the first client and second client. If not rejected, step S337 is performed, wherein the subscription to the first service succeeds; if rejected, step S339 is performed to transmit an error notification to the client to inform the client to reconfigure the first subscription priority.

Specifically, the ADCU and IVI transmit messages containing the value of the first subscription priority to the XCU according to the aforementioned method. In one example, if the first subscription priority set by ADCU (or IVI) exceeds its preset range or contains a format error, XCU rejects ADCU's (or IVI's) subscription to the radar service and transmits an error notification to ADCU (or IVI) to instruct it to reconfigure the first subscription priority. In one implementation, a whitelist may be pre-established, allowing a default range to be set for the subscription priority of electronic control units in different functional domains to determine whether an electronic control unit is misusing a high priority when setting its subscription priority.

In another example, if the first subscription priority set by the IVI is higher than that set by the ADCU, the XCU will reject the IVI's subscription to the radar service and transmit an error notification to the IVI to inform it to reset the first subscription priority. Specifically, the upper limit of the default range for ECUs in driving safety-related functional domains is smaller, while the lower limit of the default range for ECUs in entertainment-related functional domains is larger. Accordingly, when the first subscription priority set by the IVI is higher than that set by the ADCU, the XCU can determine that the IVI's first subscription priority is abnormal and issue an error notification to the IVI. This mechanism ensures the transmission sequence of service events aligns with the system's overall real-time performance and stability.

Reference is made to FIG. 3. After the first client and second client set their first subscription priorities, step S350 proceeds. In response to an event corresponding to the first service being triggered, the server compares the first subscription priorities of the first client and second client. Next, in step S370, based on the comparison result of the first subscription priorities, the server transmits the data of the first service to the client with the higher first subscription priority. Then, in step S390, the server transmits the data of the first service to the client with the lower first subscription priority.

Specifically, when a radar service event is triggered, the XCU compares the first subscription priorities of the ADCU and IVI. Since the ADCU's primary subscription priority is higher than that of the IVI, the XCU first transmits the radar service data to the ADCU. Subsequently, it transmits the radar service data to the IVI. This approach prevents the XCU from transmitting radar service data to the IVI before the ADCU, thereby avoiding potential driving safety risks caused by data delays to the ADCU.

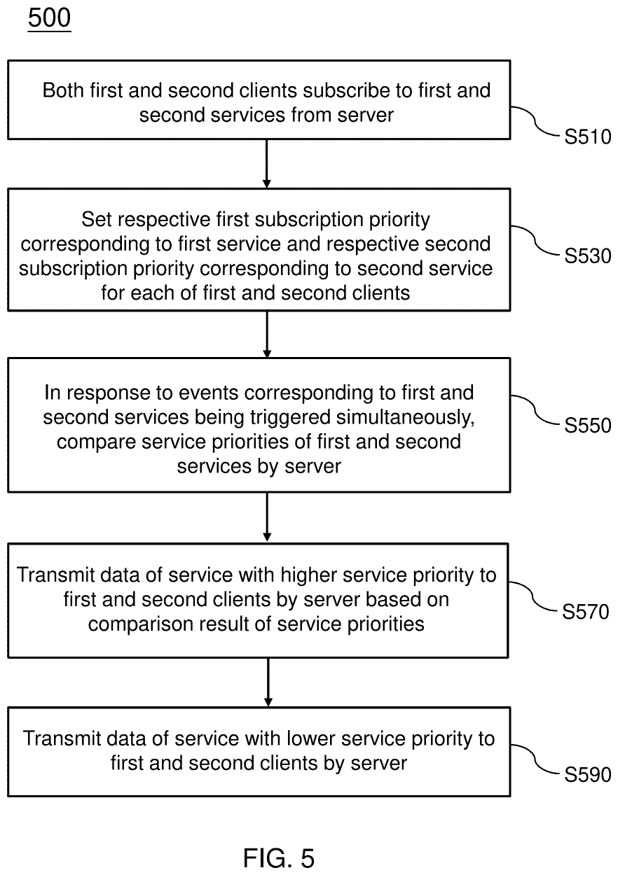

References are made to FIG. 1 and FIG. 5. FIG. 5 is a flowchart of a data transmission method 500 based on the SOME/IP communication protocol, according to another embodiment of the present disclosure. First, in step S510, both the first client and the second client subscribe to the first service and the second service from the server. Next, in step S530, the first subscription priority corresponding to the first service and the second subscription priority corresponding to the second service are set for the first client and the second client, respectively. The specific procedures for steps S510 and S530 may be referenced from the aforementioned embodiment and are not repeated here.

Subsequently, in step S550, in response to events corresponding to the first service and second service being triggered simultaneously, the server compares the service priorities of the first service and second service. Then, in step S570, based on the comparison result of the service priorities, the server transmits data for the service with the higher priority (e.g., the first service) to the first client and the second client. Subsequently, in step S590, the server transmits data for the service with the lower priority (i.e., the second service) to the first client and the second client.

In one embodiment, step S570 may further include the following steps. The server compares the first subscription priority of the first client and the second client. Next, based on the comparison result of the first subscription priority, the server transmits the data of the first service to the client with the higher first subscription priority (e.g., the first client). Subsequently, the server transmits the data of the first service to the client with the lower first subscription priority (i.e., the second client).

In an embodiment, step S590 may further include the following steps. The server compares the second subscription priorities of the first client and the second client. Next, based on the comparison result of the second subscription priorities, the server transmits the data of the second service to the client with the higher second subscription priority (e.g., the first client). Then, the server transmits the data of the second service to the client with the lower second subscription priority (i.e., the second client).

Specifically, when both ADCU and IVI subscribe to the radar service and audio-visual service provided by XCU, and events for both the radar service and audio-visual service are triggered simultaneously, XCU may first compare the service priorities of the radar service and audio-visual service to determine which service should be responded to first. Since the radar service has a higher service priority, the XCU transmits the radar service data to both ADCU and IVI first, followed by the audio-visual (AV) service data to both ADCU and IVI. Additionally, because ADCU's subscription priority for the radar service is higher than IVI's, the XCU transmits the radar service data to ADCU first, then to IVI. Similarly, since the ADCU's subscription priority for the AV service is higher than that of the IVI, the XCU transmits the AV service data to the ADCU first, followed by transmission to the IVI.

It should be noted that although the data transmission method 300 in FIG. 3 and the data transmission method 500 in FIG. 5 are described based on event-driven services, the proposed priority determination mechanism is equally applicable to request-driven services. The scope of this disclosure is not limited thereto.

In summary, according to the data transmission methods 200, 300, and 500 provided in the present disclosure, the immediacy of data transmission can be ensured. First, by assigning priorities to all services provided by the server, safety-related critical data can be transmitted preferentially. Second, by assigning priorities to all contending clients, safety-related critical data can be preferentially transmitted to the electronic control units associated with functional domains for safe driving, thereby ensuring the immediacy of critical data and reducing driving risks. The service priorities can be predefined in the ARXML file of the initial configuration of the AUTOSAR architecture. The subscription priorities can be dynamically adjusted by the clients, while a debugging mechanism is also provided to prevent abuse of high-priority rights. Therefore, high compatibility and scalability can be achieved within the existing SOME/IP communication protocol.

Although the present disclosure has been described in considerable detail with reference to certain embodiments thereof, the present disclosure is not limited thereto. It will be apparent to those skilled in the art that various modifications and variations can be made to the present disclosure without departing from the scope or spirit of the present disclosure. Therefore, the scope of the present disclosure shall be defined by the appended claims.

What is claimed is:

1. An in-vehicle electronic system based on the SOME/IP communication protocol, comprising:
a first electronic control unit serving as a server configured to provide a first service and a second service, wherein the first service and the second service each have a service priority, and the service priority of the first service is higher than the service priority of the second service; and
a second electronic control unit serving as a first client configured to request or subscribe to services provided by the server;
wherein in response to the first client simultaneously requesting the first service and the second service, or in response to the first client subscribing to the first service and the second service and events corresponding to the first service and the second service being triggered simultaneously, the server is configured to transmit data of the first service and data of the second service to the first client in sequence based on the service priorities.

2. The in-vehicle electronic system of claim 1, further comprising a third electronic control unit serving as a second client, wherein each of the first client and the second client subscribes to the first service and has a first subscription priority corresponding to the first service, wherein in response to the event corresponding to the first service being triggered, the server is configured to sequentially transmit the data of the first service to the first client and the second client according to the first subscription priorities, wherein the first subscription priority of the first client is higher than the first subscription priority of the second client.

3. The in-vehicle electronic system of claim 2, wherein each of the first client and the second client further subscribes to the second service and has a second subscription priority corresponding to the second service, wherein in response to the events corresponding to the first service and the second service being triggered simultaneously, the server is configured to transmit the data of the first service to the first client and the second client first, based on the service priorities, and then to transmit the data of the second service to the first client and the second client.

4. The in-vehicle electronic system of claim 3, wherein the server is further configured to sequentially transmit the data of the first service to the first client and the second client based on the first subscription priorities, and to sequentially transmit the data of the second service to the first client and the second client based on the second subscription priorities, wherein the second subscription priority of the first client is higher than the second subscription priority of the second client.

5. The in-vehicle electronic system of claim 2, wherein in response to the first client and the second client subscribing to the first service, each of the first client and the second client presets the respective first subscription priority to be provided to the server, and the server is configured to determine whether to reject the subscriptions of the first client and the second client to the first service based on the first subscription priorities provided by the first client and the second client.

6. The in-vehicle electronic system of claim 5, wherein in response to the first subscription priority provided by the first client exceeding a preset range or having an incorrect format, the server rejects the subscription of the first client to the first service, and transmits an error notification to the first client to notify the first client to reset the first subscription priority.

7. The in-vehicle electronic system of claim 5, wherein in response to the first subscription priority provided by the second client being higher than the first subscription priority provided by the first client, the server rejects the subscription of the second client to the first service, and transmits an error notification to the second client to notify the second client to reset the first subscription priority.

8. The in-vehicle electronic system of claim 5, wherein in response to the first client and the second client subscribing to the first service, each of the first client and the second client sets the first subscription priority in first 8 bits of a reserved field in a header of their respective SOME/IP messages during a service discovery phase of SOME/IP.

9. The in-vehicle electronic system of claim 1, wherein the in-vehicle electronic system employs an AUTOSAR architecture, and the service priorities of the first service and the second service are predefined in an ARXML file of the AUTOSAR architecture.

10. The in-vehicle electronic system of claim 9, wherein the ARXML file of the AUTOSAR architecture further defines latencies and bandwidths of the first service and the second service.

11. A data transmission method based on the SOME/IP communication protocol, suitable for an in-vehicle electronic system comprising a first electronic control unit and a second electronic control unit, the first electronic control unit serving as a server configured to provide a first service and a second service, and the second electronic control unit serving as a first client to request or subscribe to services provided by the server, wherein the data transmission method comprises:
predefining respective service priorities for the first service and the second service, wherein the service priority of the first service is higher than the service priority of the second service;
in response to the first client simultaneously requesting the first service and the second service, or in response to the first client subscribing to the first service and the second service and events corresponding to the first service and the second service being triggered simultaneously, comparing the service priorities of the first service and the second service by the server;
first transmitting data of the first service to the first client by the server based on a comparison result of the service priorities; and
transmitting data of the second service to the first client by the server after transmitting the data of the first service to the first client.

12. The data transmission method of claim 11, wherein the in-vehicle electronic system further comprises a third electronic control unit serving as a second client, and the data transmission method comprises:
subscribing to the first service by the first client and the second client;
setting a respective first subscription priority corresponding to the first service for each of the first client and the second client, wherein the first subscription priority of the first client is higher than the first subscription priority of the second client;
in response to the event corresponding to the first service being triggered, comparing the first subscription priorities of the first client and the second client by the server;
transmitting the data of the first service to the first client by the server based on a comparison result of the first subscription priorities; and
transmitting the data of the first service to the second client by the server after transmitting the data of the first service to the first client.

13. The data transmission method of claim 12, further comprising:
subscribing to the second service by the first client and the second client;
setting a respective second subscription priority corresponding to the second service for each of the first client and the second client, wherein the second subscription priority of the first client is higher than the second subscription priority of the second client;
in response to the events corresponding to the first service and the second service being simultaneously triggered, comparing the service priorities of the first service and the second service by the server;
transmitting the data of the first service to the first client and the second client by the server based on the comparison result of the service priorities; and
transmitting the data of the second service to the first client and the second client by the server after transmitting the data of the first service to the first client and the second client.

14. The data transmission method of claim 13, wherein the step of transmitting the data of the first service to the first client and the second client by the server based on the comparison result of the service priorities comprises:
comparing the first subscription priorities of the first client and the second client by the server;
transmitting the data of the first service to the first client by the server based on the comparison result of the first subscription priorities; and
transmitting the data of the first service to the second client by the server after transmitting the data of the first service to the first client.

15. The data transmission method of claim 13, wherein the step of transmitting the data of the second service to the first client and the second client comprises:
comparing the second subscription priorities of the first client and the second client by the server;
transmitting the data of the second service to the first client by the server based on a comparison result of the second subscription priorities; and
transmitting the data of the second service to the second client by the server after transmitting the data of the second service to the first client.

16. The data transmission method of claim 12, wherein the step of setting the respective first subscription priority corresponding to the first service for each of the first client and the second client comprises:
presetting the respective first subscription priority by each of the first client and the second client;
providing the first subscription priorities set by the first client and the second client to the server; and
determining whether to reject the subscriptions of the first client and the second client to the first service by the server based on the first subscription priorities provided by the first client and the second client.

17. The data transmission method of claim 16, wherein the step of setting the respective first subscription priority further comprises:
in response to the first subscription priority provided by the first client exceeding a preset range or having an incorrect format, rejecting the subscription of the first client to the first service by the server and transmitting an error notification to the first client to notify the first client to reset the first subscription priority.

18. The data transmission method of claim 16, wherein the step of setting the respective first subscription priority further comprises:
in response to the first subscription priority provided by the second client being higher than the first subscription priority provided by the first client, rejecting the subscription of the second client to the first service by the server and transmitting an error notification to the second client to notify the second client to reset the first subscription priority.

19. The data transmission method of claim 16, wherein the step of presetting the respective first subscription priority by each of the first client and the second client comprises:
setting the respective first subscription priority in first 8 bits of a reserved field in a header of their respective SOME/IP messages during a service discovery phase of SOME/IP by the first client and the second client.

20. The data transmission method of claim 11, wherein the in-vehicle electronic system employs an AUTOSAR architecture, and the step of predefining the respective service priorities for the first service and the second service comprises:
predefining the respective service priorities of the first service and the second service in an ARXML file of the AUTOSAR architecture.
